(19) United States
(12) Patent Application Publication
(10) Pub. No.: US 2026/0003135 A1
(43) Pub. Date: Jan. 1, 2026

(54) METHOD AND APPARATUS FOR FIXTURING A FERRULE OF A FIBER OPTIC CONNECTOR DURING END FACE POLISHING

(71) Applicant: CORNING RESEARCH & DEVELOPMENT CORPORATION, Corning, NY (US)

(72) Inventors: Brian Paul Daugherty, Horseheads, NY (US); Kevin Eugene Elliott, Newton, NC (US); Trevor Hampton Fry, Hickory, NC (US); Alvin John McDonald, Lenoir, NC (US)

(21) Appl. No.: 19/243,290

(22) Filed: Jun. 19, 2025

Related U.S. Application Data
(60) Provisional application No. 63/664,981, filed on Jun. 27, 2024.

(51) Int. Cl. G02B 6/38; B24B 19/22; B24B 41/06

(52) U.S. Cl. CPC G02B 6/3863; B24B 19/226; B24B 41/067

(57) ABSTRACT

A method of polishing a ferrule of a fiber optic connector is disclosed. The ferrule includes a plurality of optical fibers connected thereto and at least two reference datums, one being a primary reference datum and another being a secondary reference datum. The method includes inserting the ferrule in a port of a fixture, securing the ferrule within the port of the fixture, and polishing an end face of the ferrule while the ferrule is secured to the port of the fixture. The securing step includes imposing a first clamping force on the ferrule to engage the secondary reference datum of the ferrule with the fixture, and subsequently imposing a second clamping force on the ferrule to engage the primary reference datum of the ferrule with the fixture. A fixture for polishing a ferrule according to the method is also disclosed.

### PRIORITY APPLICATION

This application claims the benefit of priority of U.S. Provisional Application No. 63/664,981, filed on Jun. 27, 2024, the content of which is relied upon and incorporated herein by reference in its entirety.

### TECHNICAL FIELD

This disclosure relates generally to fiber optic connectivity, and more particularly to a method of positioning a ferrule of a fiber optic connector in a predetermined location in a fixture during polishing of the ferrule end face, and to an apparatus for clamping the ferrule to the fixture at the predetermined location prior to polishing of the ferrule end face.

### BACKGROUND

Optical fibers are useful in a wide variety of applications, including the telecommunications industry for voice, video, and data transmissions. Benefits of optical fibers include wide bandwidth and low noise operation. In a telecommunications system that uses optical fibers, there are typically many locations where fiber optic cables containing the optical fibers connect to equipment or other fiber optic cables. To conveniently provide these connections, fiber optic connectors are often provided on the ends of fiber optic cables to non-permanently connect and disconnect optical elements in the fiber optic network. The process of terminating individual optical fibers from a fiber optic cable is referred to as “connectorization.” Connectorization can be done in a factory, resulting in a “pre-connectorized” or “pre-terminated” fiber optic cable, or the field (e.g., using a “field-installable” fiber optic connector).

The introduction of fiber optic connectors, however, may introduce insertion losses across an optical connection, e.g., at the junction between two or more optical fibers. One common optical connection in a network is one between two mated fiber optic connectors. It should be recognized, however, that the term “optical connection” may encompass other types of junctions between optical fibers. The insertion losses in coupling two optical fibers across an optical connection are generally a function of the alignment of the optical fiber ends, the width of the gap between the ends, and the optical surface condition at the ends. To minimize insertion losses, processes have been developed for reducing misalignments of the optical fibers across the optical connection and for optimizing the geometry and cleanliness of the optical fiber end faces.

A fiber optic connector typically includes a ferrule having one or more bores for receiving the optical fibers carried by the fiber optic cable. The ferrule holds the ends of the optical fiber and includes a ferrule end face for presentation of the ends of the optical fibers for optically communicating with corresponding optical fibers across the optical connection. The fiber optic connector further includes a connector housing assembly (also referred to as a connector body) which is configured to receive the ferrule within the housing assembly. The connector housing assembly is configured to mate with an optical device (e.g., adapter, equipment port, etc.) so that the ferrule, and more particularly the end faces of the one or more optical fibers received therein, is accurately positioned at a predetermined location. The optical fibers across the connection interface are similarly accurately positioned at a predetermined location such that misalignments of the optical fibers across the optical connection, and the resulting insertion losses, are minimized.

As noted above, optical losses across an optical connection may also be introduced by defects and debris at the end faces of the ferrule and optical fibers of the fiber optic connectors. To avoid such optical losses, the end faces of the ferrule and optical fibers in a fiber optic connector may be subjected to a number of processes to ensure a desired end face geometry and desired level of cleanliness. By way of example, during manufacture of the fiber optic connector, the optical fibers are inserted into the respective bores in the ferrule such that a small length of fiber extends beyond the end face of the ferrule. The optical fibers are then secured to the ferrule, such as by applying an adhesive within the bores. Subsequently, the ferrule end face is subjected to a polishing process. The polishing process aids in providing the desired end face geometry and in removing certain defects from the end faces of the optical fibers and the end face of the ferrule, such as scratches, pits, digs, as well as adhesives and contaminates, to provide a clean, well-defined mating interface.

It is important that the polishing step of the connectorization process maintains/achieves the desired precise geometry of the ferrule/fiber end faces. Indeed, in many cases, the optical fiber and ferrule end faces must conform to relevant industry standards that specify requirements for different physical contact geometries. Examples of physical contact geometries known in the industry include, but are not limited to, physical contact (PC), angled physical contact (APC), and ultra physical contact (UPC) geometries. Thus, the challenge is to polish down the protrusions of the optical fibers from the ferrule end face to an acceptable height (e.g., within 50 microns of the ferrule end face) and to polish out defects in the optical fibers and ferrule in a manner that does not alter the end face geometry. This may be achieved, for example, by engaging the ferrule/fiber end faces with an abrasive element, which may take the form of an abrasive sheet or film, or an abrasive slurry.

Various ferrule polishing fixtures have been developed to fixate or hold the ferrule in a precise and predetermined position relative to the fixture when polishing the end faces of the ferrule and optical fibers. Such fixtures typically include a port that receives the ferrule and a clamp mechanism that applies forces to the ferrule in order to clamp the ferrule at the predetermined location within the port of the fixture. In this regard, the fixture port typically includes a plurality of reference datums that engage with corresponding reference datums on the ferrule when acted upon by the clamp mechanism. Once the ferrule is securely clamped in its precise, predetermined location within the port of the fixture, polishing the end face of the ferrule and optical fibers may commence. The forces imposed by the clamp mechanism on the ferrule must be of sufficient magnitude to prevent the ferrule from moving within the port and away from its predetermined location during polishing.

While current polishing fixtures are generally successful for current ferrule designs, the continued reduction in size of optical fibers, fiber optic cables, and fiber optic connectors, including ferrules of the fiber optic connectors, presents certain challenges in fixturing the ferrules during polishing. In this regard, due to their decreased size, the ferrules for more recent very small form factor fiber optic connectors are difficult to accurately clamp, and therefore difficult to position in a precise, predetermined location within the port of the fixture. Because in many cases the ferrule is not precisely positioned within the port, the polishing process results in the geometries of the end faces of the ferrule and optical fibers being different from their desired geometries. This, in turn, leads to increased insertion losses across the optical connection.

In view of the above, there is a need in the telecommunications industry for a fixture having a clamp mechanism that precisely locates very small form factor ferrules within a port. There is also a need for a method of clamping very small form factor ferrules in precise predetermined locations within a port of the fixture.

### SUMMARY

In one aspect of the disclosure, a method of polishing a ferrule of a fiber optic connector that overcomes the drawbacks discussed above is disclosed. The ferrule includes a plurality of fiber bores each receiving a respective one of a plurality of optical fibers. The ferrule further includes at least two reference datums, where one of the at least two reference datums is a primary reference datum and another of the at least two reference datums is a secondary reference datum. The method includes inserting the ferrule in a port of a fixture, securing the ferrule within the port of the fixture, and polishing an end face of the ferrule while the ferrule is secured to the port of the fixture. The securing step includes imposing a first clamping force (F₁) on the ferrule to engage the secondary reference datum of the ferrule with a first reference datum associated with the fixture, and subsequently imposing a second clamping force (F₂) on the ferrule to engage the primary reference datum of the ferrule with a second reference datum associated with the fixture.

In one embodiment, imposing the first clamping force (F₁) on the ferrule may include imposing the first clamping force (F₁) with a first magnitude (M₁) and imposing the second clamping force (F₂) on the ferrule may include imposing the second clamping force (F₂) with a second magnitude (M₂), wherein the second magnitude (M₂) is greater than the first magnitude (M₁). Thus, the magnitude of the force that secures the primary reference datum of the ferrule to the fixture is greater than the magnitude of the force that secures the secondary reference datum of the ferrule to the fixture.

In one embodiment, imposing the first clamping force (F₁) on the ferrule may include activating a first clamp mechanism and imposing the second clamping force (F₂) on the ferrule may further include activating a second clamp mechanism. In this embodiment, the first clamp mechanism and the second clamp mechanism may be separate and independently controlled. In one embodiment, the method may further include reducing the magnitude (M₁) of the first clamping force (F₁) after the second clamping force (F₂) has been imposed. In another embodiment, imposing the first clamping force (F₁) on the ferrule and imposing the second clamping force (F₂) on the ferrule may include activating a first clamp mechanism to impose both the first clamping force (F₁) and the second clamping force (F₂) on the ferrule. In other words, a single clamp mechanism is arranged to provide both the first clamping force (F₁) and the second clamping force (F₂).

In one embodiment, the at least two reference datums of the ferrule may further include a tertiary reference datum. In this embodiment, the method may further include imposing a third clamping force (F₃) on the ferrule to engage the tertiary reference datum of the ferrule with a third reference datum associated with the fixture. In one embodiment, imposing the third clamping force (F₃) on the ferrule may include imposing the third clamping force (F₃) on the ferrule prior to imposing a first clamping force (F₁) on the ferrule. In one embodiment, imposing the third clamping force (F₃) on the ferrule may include imposing the third clamping force (F₃) with a third magnitude (M₃), where the third magnitude (M₃) may be less than the first magnitude (M₁). In another embodiment, imposing the third clamping force (F₃) on the ferrule may include activating a third clamp mechanism. In this embodiment, the third clamp mechanism may be separate from the first clamp mechanism and independently controlled.

In one embodiment, the ferrule may include a generally rectangular ferrule body defining a top surface, a bottom surface, opposed side surfaces, a front end face, and a rear end face. The plurality of fiber bores extends between the rear end face and the front end face. The ferrule may further include a cavity in the top surface of the ferrule body that extends from the front end face toward the rear end face for part of a length of the ferrule, the cavity being open to the front end face of the ferrule body and including opposed side walls and a rear wall, and the cavity extending from the top surface toward the bottom surface for part of a height of the ferrule body. In one embodiment, the top surface of the ferrule body may serve as the primary reference datum and the rear wall of the cavity in the top surface may serve as the secondary reference datum.

In another aspect of the disclosure, a fixture for polishing a ferrule of a fiber optic connector is disclosed. The ferrule includes a plurality of fiber bores that receive a plurality of optical fibers. The ferrule further includes at least two reference datums, one of the at least two reference datums being a primary reference datum and another of the at least two reference datums being a secondary reference datum. The fixture includes a fixture port configured to receive the ferrule therein and at least one clamp mechanism for securing the ferrule within the port of the fixture in a predetermined location. The at least one clamp mechanism is configured to impose a first clamping force (F₁) on the ferrule to engage the secondary reference datum of the ferrule with a first reference datum associated with the fixture, and subsequently impose a second clamping force (F₂) on the ferrule to engage the primary reference datum of the ferrule with a second reference datum associated with the fixture.

In one embodiment, the at least one clamp mechanism may include a plurality of clamp mechanisms, wherein the plurality of clamp mechanisms may include a first clamp mechanism for imposing the first clamping force (F₁) on the ferrule and a second clamp mechanism for imposing the second clamping force (F₂) on the ferrule. In this embodiment, the first clamp mechanism and the second clamp mechanism may be separate from each other and independently controlled. In an alternative embodiment, the at least one clamp mechanism may include a first clamp mechanism for imposing the first clamping force (F₁) on the ferrule and imposing the second clamping force (F₂) on the ferrule.

In one embodiment, the first clamp mechanism may include an actuator arm movable along an actuator axis between an extended position and a retracted position and a headpiece connected to an end of the actuator arm. In the extended position, the headpiece is configured to contact the ferrule and secure the ferrule to the port of the fixture in the predetermined position. Moreover, in the retracted position, the headpiece is configured to be in non-contact relation with the ferrule. In one embodiment, the at least one clamp mechanism may include a motive force generator for moving the actuator arm between the extended position and the retracted position.

In one embodiment, the headpiece may include a rotational degree of freedom relative to the actuator arm. In this regard, in one embodiment, the headpiece may be connected to the actuator arm via a ball and socket joint that provides the rotational degree of freedom. In another embodiment, the first clamp mechanism may further include a spring to bias the headpiece relative to the actuator arm.

In one embodiment, the at least one clamp mechanism may be configured to impose the first clamping force (F₁) with a first magnitude (M₁) and impose the second clamping force (F₂) with a second magnitude (M₂). In this embodiment, the second magnitude (M₂) may be greater than the first magnitude (M₁).

In one embodiment, the at least two reference datums of the ferrule may further include a tertiary reference datum. Moreover, the at least one clamp mechanism may include a third clamp mechanism configured to impose a third clamping force (F₃) on the ferrule. In one embodiment, the third clamp mechanism is configured to impose the third clamping force (F₃) with a third magnitude (M₃) that is less than the first magnitude (M₁).

In another aspect of the disclosure, a method of making a fiber optic cable assembly is disclosed. The method includes stripping an end of a fiber optic cable carrying a plurality of optical fibers to expose a length of the optical fibers, loading one or more components of a fiber optic connector onto the stripped end of the fiber optic cable, securing the optical fibers to a ferrule of the fiber optic connector, and polishing an end face of the ferrule according to the first aspect described above. The method may further include assembling the one or more components with the ferrule to complete the assembly of the fiber optic connector on the end of the fiber optic cable.

In one embodiment, loading one or more components of the fiber optic connector onto the fiber optic cable may further include loading one or more of a boot subassembly, a crimp band, at least a portion of a body, a spring, and optionally a guide pin subassembly onto the fiber optic cable. In one embodiment, the method may further include inserting the ferrule into a shroud of the fiber optic connector, connecting the shroud to the housing portion so as to bias the ferrule with the spring, applying the crimp band to the crimp body to fix the crimp body relative to the plurality of optical fibers, and positioning the boot subassembly relative to the crimp body.

Additional features and advantages will be set forth in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a perspective view of a fiber optic cable assembly having a fiber optic cable terminated by an MMC fiber optic connector.

FIG. 2 is a disassembled perspective view of the MMC fiber optic connector shown in FIG. 1.

FIG. 3 is a disassembled perspective view of the crimp body and the housing portion of the MMC fiber optic connector shown in FIGS. 1 and 2.

FIG. 4 is a perspective view of a very small form factor ferrule in the form of a TMT ferrule and connected fiber optic cables.

FIG. 5 is an enlarged perspective view of the TMT ferrule shown in FIG. 4.

FIG. 6 is a side schematic view of a polishing fixture according to existing designs.

FIG. 7 is another side schematic view of the polishing fixture shown in FIG. 6 illustrating the mispositioning of the ferrule in the port of the fixture.

FIG. 7A is a front schematic view of a polishing fixture according to existing designs.

FIG. 8 is an exemplary method for securing a workpiece within a processing fixture in accordance with an embodiment of the disclosure.

FIG. 9 is a partial perspective view of a polishing fixture in accordance with an embodiment of the disclosure having a port and at least one clamp mechanism.

FIG. 10 is a perspective view of the clamp mechanism shown in FIG. 9 in accordance with an embodiment of the disclosure.

FIG. 11 is an enlarged side view of the headpiece of the clamp mechanism shown in FIG. 10 engaging with a ferrule in the port of the fixture.

FIG. 12 is another enlarged side view of the headpiece of the clamp mechanism shown in FIG. 10 securing the ferrule to the port of the fixture.

FIG. 12A is an enlarged front view of the headpiece of the clamp mechanism shown in FIG. 10 engaging with a ferrule in the port of the fixture.

### DETAILED DESCRIPTION

The exemplary embodiments described herein are provided for illustrative purposes and are not limiting. Other exemplary embodiments are possible, and modifications may be made to the exemplary embodiments within the scope of the present disclosure. Therefore, the description below is not meant to limit the scope of the present disclosure. In general, the description relates to a method of consistently positioning a ferrule of a fiber optic connector in a predetermined location in a port of a polishing fixture. The ferrule includes at least two reference datums, one of which operates as the primary reference datum for the ferrule and another of which operates as the secondary reference datum for the ferrule. The method includes first clamping the ferrule in the port of the fixture by: i) engaging the secondary reference datum with a corresponding reference datum in the port of the fixture; and ii) engaging the primary reference datum with a corresponding reference datum in the port of the fixture. In other words, securing of the ferrule in the port of the fixture has a specific sequence as it relates to the primary and secondary reference datums of the ferrule. Additionally, further advantages may be gained through a specific sequencing of the magnitudes of the clamping forces imposed on the ferrule. In this regard, certain advantages may be gained by engaging the secondary reference datum to the port of the fixture with a magnitude in the clamping force that is less than the magnitude of the clamping force in which the primary reference datum is engaged to the port of the fixture. In other words, the magnitudes of the clamping forces used to secure the ferrule to the port of the fixture may also have a specific sequence as it relates to the primary and secondary reference datums of the ferrule. These and other aspects of the present disclosure are described in more detail below.

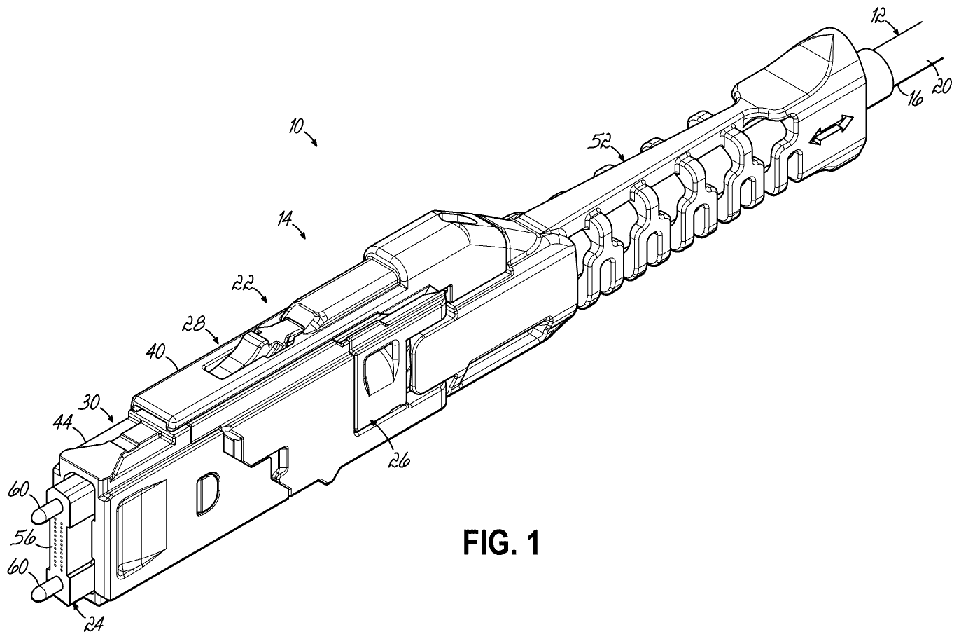

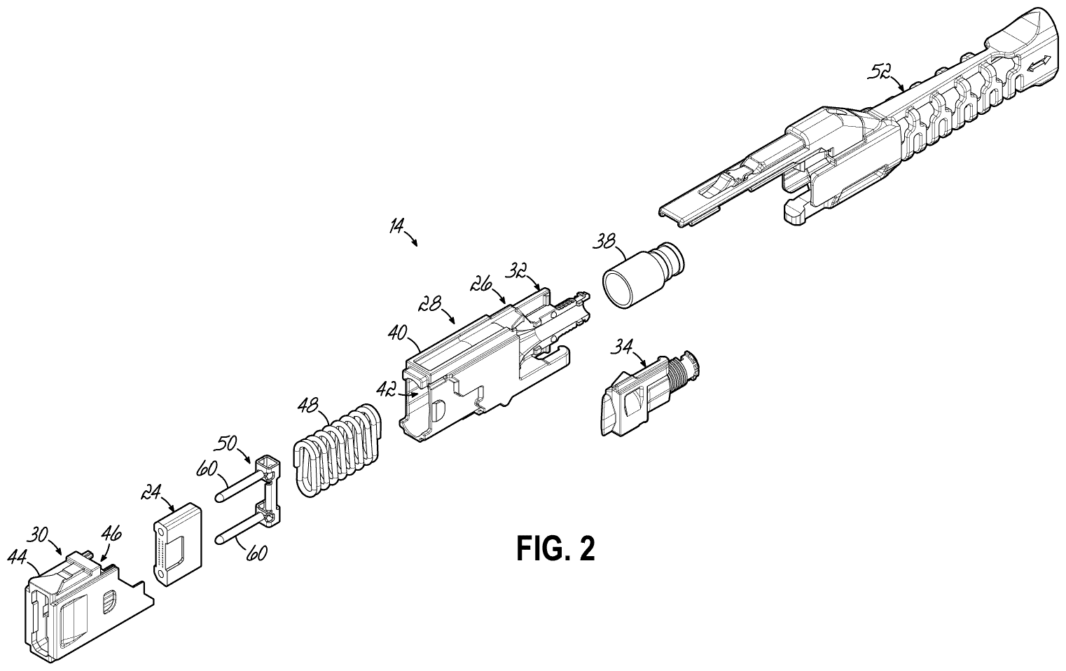

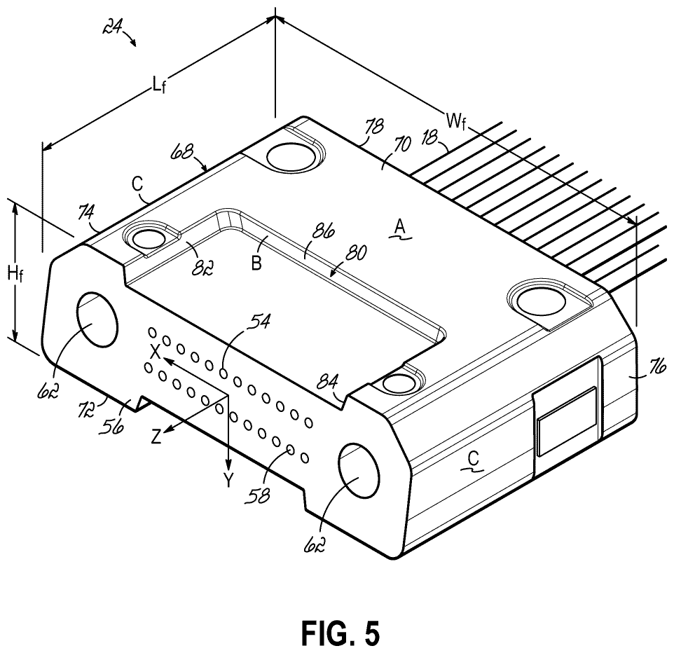

As illustrated in FIGS. 1 and 2, an exemplary fiber optic cable assembly 10 includes a fiber optic cable 12 and at least one fiber optic connector 14 terminating the fiber optic cable 12 at a first end 16 of the of the fiber optic cable 12 (one shown). A second opposite end (not shown) of the fiber optic cable 12 may also include a fiber optic connector, e.g., similar to fiber optic connector 14, terminating the fiber optic cable 12 at that end. The fiber optic cable 12 carries a plurality of optical fibers 18 (see FIG. 4) within an outer jacket or sheath 20 of the fiber optic cable 12. In one embodiment, for example, the fiber optic cable 12 may carry twelve optical fibers 18. In an alternative embodiment, however, the fiber optic cable 12 may carry a plurality of cable subunits (e.g., six or eight cable subunits; not shown), where each cable subunit may carry a plurality of optical fibers, such as twelve optical fibers 18. It should be appreciated, however, that the fiber optic cable 12 and/or the cable subunits of the fiber optic cable 12 may carry more of less optical fibers depending on the particular application.

Through the process of connectorization, the optical fibers 18 carried by the fiber optic cable 12 may be terminated by one or more fiber optic connectors 14 (one shown). The fiber optic connector 14 of the fiber optic cable assembly 10 generally includes a housing assembly 22 and a ferrule 24 substantially positioned in the housing assembly 22. In the embodiment, shown in FIGS. 1 and 2, the fiber optic connector 14 is illustrated as an MMC fiber optic connector sold by US Conec Ltd. The MMC fiber optic connector is considered to be part of a class of fiber optic connectors referred to as very small form factor (VSFF) connectors, which have small footprint ferrules 24 and connector housing assemblies compared to standard fiber optic connectors in the telecommunications industry. By way of example, and as discussed in more detail below, the MMC fiber optic connector utilizes a very small form factor MT-style ferrule, referred to as a TMT ferrule. Aspects of the present disclosure are directed to polishing processes for VSFF ferrules, such as the TMT ferrule of the MMC fiber optic connector, and their associated optical fibers 18. While aspects of the disclosure will be described in reference to the MMC fiber optic connector and the TMT ferrule, it should be understood that aspects of the disclosure are applicable to other fiber optic connectors (and more specifically the ferrules used therein), including both conventional multifiber fiber optic connectors and VSFF fiber optic connectors other than the MMC fiber optic connector.

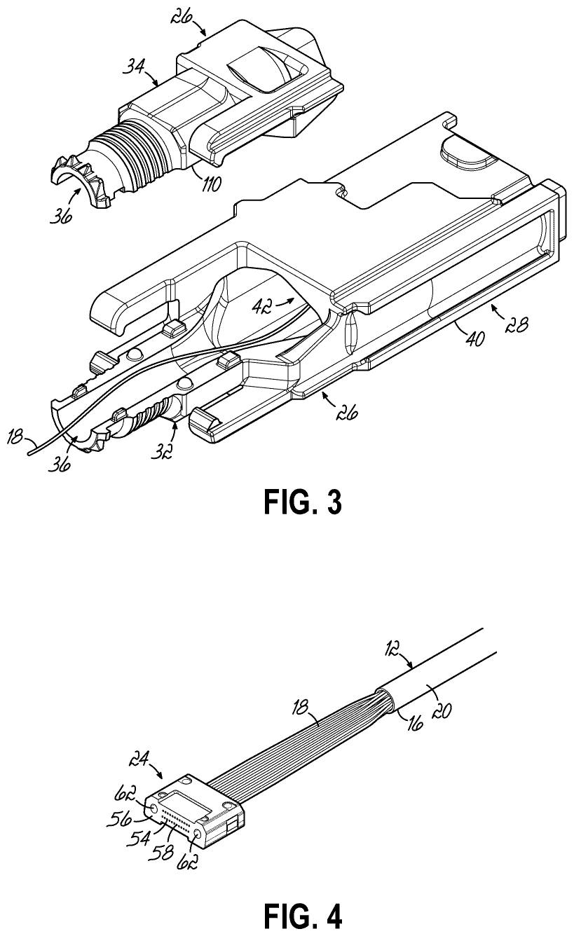

As illustrated in FIGS. 1-3, the MMC housing assembly 22 may include a crimp body 26 (also referred to as a rear housing component or body in this disclosure) and a shroud 30 (also referred to as a front housing component or body in this disclosure). The crimp body 26 may have a two-part construction including a first crimp body portion 32 and a second crimp body portion 34 that are configured to be mated together (such as along a midline) to form the crimp body 26. Each of the first and second crimp body portions 32, 34 includes respective passageway portions such that when the first and second crimp body portions 32, 34 are clamped together, a central passageway 36 extends through the crimp body 26 and is configured to receive the plurality of optical fibers 18 carried by the fiber optic cable 12 (or subunit cable). As described below, the crimp body 26 is configured to receive a crimp band 38 along a distal portion thereof to clamp the first crimp body portion 32 and the second crimp body portion 34 together.

In the embodiment shown, the first crimp body portion 32 is integral with a housing portion 28 that includes a generally rectangular housing body 40 and a central housing passageway 42 extending through the housing body 40. The central housing passageway 42 is in communication with the crimp body passageway 36 and allows the optical fibers 18 to pass therethrough. Because the housing portion 28 may be integrally formed with the first crimp body portion 32 of the crimp body 26, the second crimp body portion 34 may operate as a housing assembly cap for accessing and closing off the distal portion of the housing assembly 22 after the ferrule 24 and optical fibers 18 received in the ferrule 24 have been inserted through the housing portion 28 of the housing assembly 22.

The shroud 30 includes a generally rectangular shroud body 44 and a central shroud passageway 46 extending through the shroud body 44. The central shroud passageway 46 is configured to be in communication with the central housing passageway 42 when the housing assembly 22 is assembled. The central shroud passageway 46 may include a seat (not shown) that receives the ferrule 24 and prevents the ferrule 24 from passing through the shroud 30. The seat is positioned near a proximal end of the shroud 30 such that a proximal portion of the ferrule 24 extends from the shroud 30 when the ferrule 24 is positioned in the seat and the shroud 30 is releasably connected to the housing portion 28 of the housing assembly 22, such as through a snap-fit type of connection. The fiber optic connector 14 may further include a spring 48 for biasing the ferrule 24 toward its seat in the shroud 30. Moreover, depending on whether the fiber optic connector 14 is a male-type connector, the fiber optic connector 14 may include a guide pin subassembly 50. The guide pin subassembly 50 may be omitted in a female-type connector. Lastly, the fiber optic connector 14 may include a boot subassembly 52 to protect any exposed optical fibers adjacent the rear of the fiber optic connector 14 from being excessively bent during use.

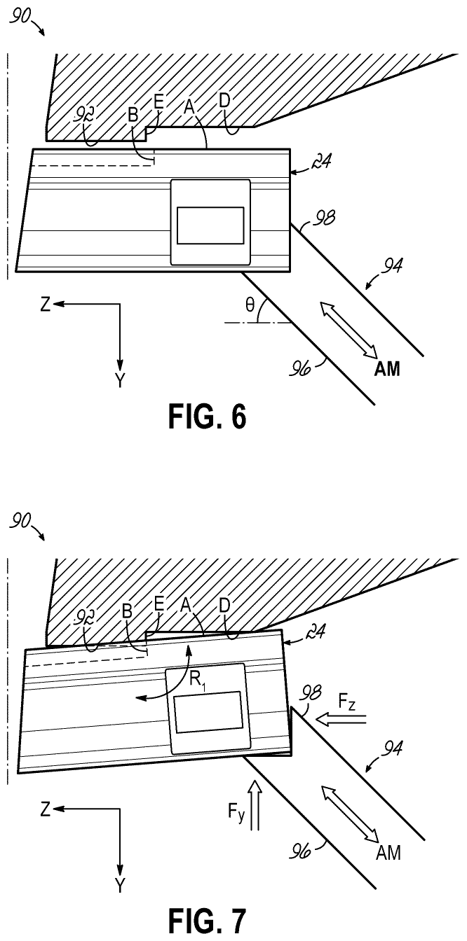

To connectorize the fiber optic cable 12 with the fiber optic connector 14, first a length of the outer sheath 20 of the fiber optic cable 12 may be stripped to provide the plurality of optical fibers 18, such as a plurality of loose or ribbonized optical fibers 18. Next, the boot subassembly 52, crimp band 38, crimp body 26 (without the second crimp body portion 34), housing portion 28, spring 48 and optionally the guide pin subassembly 50 may be loaded onto the stripped end of the fiber optic cable 12. The optical fibers 18 may then be inserted into respective fiber bores 54 of the ferrule 24. As is typical, the optical fibers 18 may be inserted into the fiber bores 54 such that a small amount of fiber extends from an end face 56 of the ferrule 24. The optical fibers 18 may then be cleaved so that their respective end faces 58 (FIG. 5) reside even closer to the end face 56 of the ferrule 24. Alternatively, cleaving may take place before inserting the optical fibers 18 into the ferrule 24, and the insertion of the optical fibers 18 into the ferrule 24 controlled so that the cleaved end faces 58 reside close to the end face 56. The optical fibers 18 may then be secured to the ferrule 24, such as by the application of adhesive within the fiber bores 54 of the ferrule 24, before or after inserting the optical fibers 18 into the fiber bores 54. The end face 56 of the ferrule 24 may be at least partially shaped during manufacture of the ferrule 24 and only a small amount of shaping may be necessary to finalize the desired end face geometry (e.g., so as to have an eight-degree angled end face profile). As was discussed above, the final stage of shaping the end face 56 of the ferrule 24 may be achieved during the polishing process of the fiber optic connector 14. Additionally, the polishing process may shape the end faces 58 of the optical fibers 18 and remove any defects, debris, etc. that may be on the end faces 56, 58 of the ferrule 24 and/or optical fibers 18, respectively. Details of the polishing process will be described in more fully below.

Subsequent to the polishing process, the ferrule 24 and optical fibers 18, along with at least a portion of the spring 48 and optionally the guide pin subassembly 50, may be inserted into the shroud 30 so that the ferrule 24 is located in its seat near the proximal end of the shroud 30. The integral housing portion 28 and first crimp body portion 32 may then be moved proximally along the optical fibers 18 so that the shroud 30 may be releasably connected to the housing portion 28. When so connected, a distal end of the spring 48 engages with a stop or shoulder (not shown) in the housing portion 28 and the proximal end of the spring 48 engages a rear of the ferrule 24 to bias the ferrule 24 in the proximal direction toward its seat in the shroud 30. If the guide pin subassembly 50 is present, the proximal end of the spring 48 is configured to engage a rear of the guide pin subassembly 50 to bias both the ferrule 24 and the guide pin subassembly 50 in the proximal direction.

As illustrated in FIGS. 1 and 2, the guide pins 60 of the guide pin subassembly 50 may extend through bores 62 in the ferrule 24 and beyond the end face 56 of the ferrule 24. The guide pins 60 are configured to be received within corresponding bores in the ferrule of the mating fiber optic connector (not shown) across the optical connection. The optical fibers 18 distal of the fiber optic connector 14 may be positioned in the passageway portion of the first crimp body portion 32. To complete the assembly of the fiber optic connector 14, the second crimp body portion 34 may be positioned over the first crimp body portion 32 and the crimp band 38 applied to a distal portion thereof so as to clamp the first and second crimp body portions 32, 34 together. The boot subassembly 52 may then be moved proximally along the fiber optic cable 12 to engage with the crimp body 26.

FIGS. 4 and 5 illustrate the fiber optic cable 12 having the optical fibers 18 carried thereby secured to the ferrule 24 of the fiber optic connector 14. For simplicity, the other components of the fiber optic connector 14 have been omitted from their position about the optical fibers 18. As discussed above, the ferrule 24 of the fiber optic connector 14 is illustrated as a multi-fiber ferrule of an MMC fiber optic connector. Such a ferrule is known as a TMT ferrule or miniature MT ferrule, and examples are described in PCT Patent Application Pub. No. WO 2021/217050 A1, the disclosure of which is herein incorporated by reference. It should be appreciated, however, that aspects of the present disclosure are not limited to the TMT ferrule and may be found advantageous to other ferrule and fiber optical connector configurations. In this embodiment, the ferrule 24 includes a generally rectangular ferrule body 68 defining a top surface 70, a bottom surface 72, opposed side surfaces 74, 76, a front end face 56, and a rear end face 78. The plurality of fiber bores 54 extends between the rear end face 78 and the front end face 56 and are configured to receive a respective one of the plurality of optical fibers 18 of the fiber optical cable 12, as mentioned above. As illustrated, the ferrule 24 may include twenty-four ferrule bores 54 to receive twenty-four optical fibers 18. It should be appreciated, however, that the ferrule 24 may include more or less fiber bores 54 for receiving more or less optical fibers 18 depending on the particular application. The ferrule 24 may also include two guide pin bores 62 extending between the rear end face 78 and the front end face 56 and configured to receive respective guide pins 60 of the guide pin subassembly 50 in the event the fiber optic connector 14 is configured as a male-type connector. In an exemplary embodiment, the guide pin bores 62 may be adjacent the opposed side surfaces 74, 76 of the ferrule body 68.

As best shown in FIG. 5, the ferrule 24 includes a depression or cavity 80 in the top surface 70 of the ferrule body 68. The cavity 80 is open to the front end face 56 of the ferrule body 68 and generally includes a pair of opposed side walls 82, 84 and a rear wall 86. In an exemplary embodiment, the side walls 82, 84 may be arranged generally parallel to the side surfaces 74, 76 of the ferrule body 68 and the rear wall 86 may be arranged generally parallel to the rear end face 78 (and front end face 56) of the ferrule body 68. The cavity 80 may extend from the front end face 56 toward the rear end face 78 in a length direction for part of the length Li of the ferrule body 68. Moreover, the cavity 80 may be centered about a vertical midplane of the ferrule body 68 and extend in a width direction for part of the width W_{f} of the ferrule body 68. Furthermore, the cavity 80 may extend from the top surface 70 toward the bottom surface 72 in a height direction for part of the height H_{f} of the ferrule body 68. It should be appreciated that the cavity 80 may have different length, width, and height dimensions depending on the embodiment.

In general, in order to clamp a workpiece within a processing fixture in a predetermined location, the workpiece will generally include at least one and preferably a plurality of reference datums. The reference datums on the workpiece are configured to cooperate with respective reference datums on the processing fixture to position the workpiece in the predetermined location. In this way, processing steps may be performed knowing that the workpiece is in its predetermined location. In this regard, the processing fixture typically includes one or more clamp mechanisms that position the workpiece in its predetermined location and secure the workpiece relative to the processing fixture in the predetermined location. The one or more clamp mechanisms apply one or more clamping forces to secure the position of the workpiece within the processing fixture. As can be appreciated, this prevents the workpiece from moving during execution of the processing steps.

In many cases, processing fixtures are configured to adjust the position of the workpiece relative to the fixture in three dimensions. This allows the workpiece to be precisely positioned at the predetermined location. For example, using a Cartesian coordinate system for description purposes, processing fixtures may be configured to adjust the workpiece in the X, Y, and Z directions and apply a clamping force in the X, Y, and Z directions to secure the workpiece to the processing fixture.

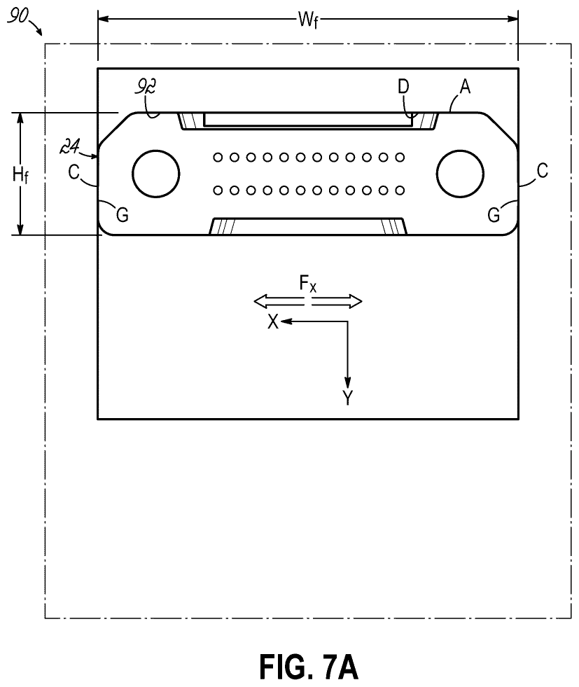

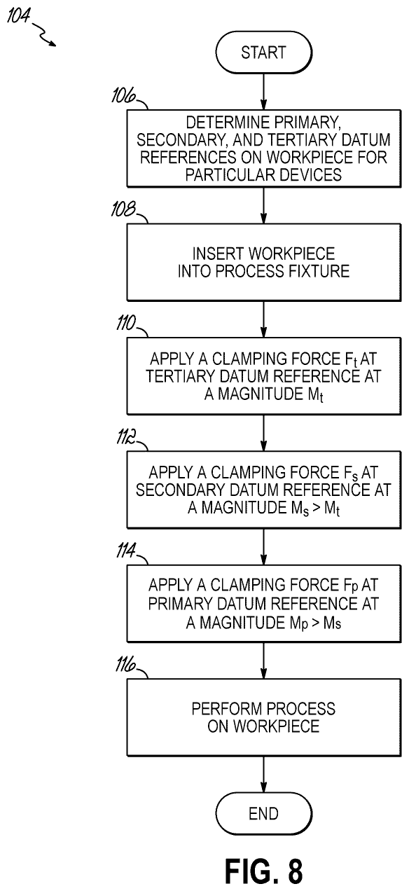

In this regard, and in reference to FIG. 5, with the ferrule 24 operating as the workpiece and a polishing fixture operating as the processing fixture, the ferrule 24 may include at least two, and possibly three datum surfaces A, B, and C used to precisely position the ferrule 24 within the polishing fixture at the predetermined location. In reference to the Cartesian coordinate system illustrated in FIG. 5, the A datum surface is configured to precisely position the ferrule 24 in the Y direction; the B datum surface is configured to precisely position the ferrule 24 in the Z direction; and the C datum surface is configured to precisely position the ferrule 24 in the X direction. And more specifically for the embodiment shown, the top surface 70 of the ferrule body 68 serves as the A datum surface, the rear wall 86 of the cavity 80 serves as the B datum surface, and at least one of the opposed side surfaces 74, 76 serves as the C datum surface. The A, B, and C datum surfaces on the ferrule 24 are configured to cooperate with corresponding D, E, and G datum surfaces (see e.g., FIGS. 6-7A) on the polishing fixture to secure the ferrule 24 in the predetermined location using the one or more clamp mechanisms. More particularly, the A datum surface of the ferrule 24 is configured to engage with the D datum surface of the polishing fixture under a clamping force F_{y} of the at least one clamp mechanism; the B datum surface of the ferrule 24 is configured to engage with the E datum surface of the polishing fixture under a clamping force F_{z} of the at least one clamp mechanism; and the C datum surface of the ferrule 24 is configured to engage with the G datum surface of the polishing fixture under a clamping force Fₓ of the at least one clamp mechanism. The clamping forces Fₓ, F_{y}, and F_{z} must have sufficient magnitudes Mₓ, M_{y}, and M_{z} to prevent the ferrule 24 from moving when subjected to the various processing steps being performed on the ferrule 24 (e.g., polishing) while in the fixture.

The inventors have discovered that as the size of multifiber ferrules have decreased, such as reaching sizes suitable for very small form factor connectors, the manner in which the ferrule 24 is clamped within the polishing fixture may have a significant impact on the quality of the processing steps performed on the ferrule 24 while in the fixture. With more particularity, the inventors have discovered that the order of application of the clamping forces Fₓ, F_{y}, and F_{z} and the relative magnitudes of the clamping forces Mₓ, M_{y}, and M_{z}, respectively, may have a significant impact on the quality of the polishing performed on the end faces 56, 58 of the ferrule 24 and the optical fibers 18, respectively.

FIGS. 6-7A schematically illustrate a conventional polishing fixture 90. The polishing fixture 90 includes a port 92 for receiving the ferrule 24 therein (optical fibers 18 have been omitted for simplicity). Although not shown, the polishing fixture 90 may include a first clamp mechanism for applying a clamping force Fₓ that engages the C datum surface of the ferrule 24 with the G datum surface of the port 92 of the polishing fixture 90. This positions the ferrule 24 within the port 92 in a precise location in the X direction. The polishing fixture 90 may further include a second clamp mechanism 94 for applying clamping forces F_{y} and F_{z} that engage: (i) the A datum surface of the ferrule 24 with the D datum surface of the port 92 of the polishing fixture 90; and (ii) the B datum surface of the ferrule 24 with the E datum surface of the port 92 of the polishing fixture 90. This positions the ferrule 24 within the port 92 of the polishing fixture 90 in a precise location in the Y direction and the Z direction, respectively. In many current polishing fixtures, a single clamp mechanism 94 provides both the F_{y} and F_{z} clamping forces on the ferrule 24. In this regard, the clamp mechanism 94 generally includes an actuator 96 movable in the Y-Z plane along a generally linear path, i.e., a linear actuator. For example, the actuator 96 may include an electric, pneumatic, hydraulic, or other type of linear actuator. The actuator 96 may include a fixed headpiece 98 for engaging with the ferrule 24 in such a way as to generate a clamping force in both the Y and Z directions. The geometry of the clamp mechanism 94 may determine the relative magnitudes M_{y}, M_{z} of the clamping forces F_{y} and F_{z}. For example, if the angle θ is 45 degrees, the magnitudes M_{y}, M_{z} of the clamping forces F_{y}, F_{z} may be substantially equal and may be applied in a simultaneous manner.

It should be noted that the B datum surface on the ferrule 24 is relatively small and it can be difficult to have the B datum surface seat so as to properly engage with the E datum surface of the polishing fixture, especially given the manner and magnitudes M_{y}, M_{z} of the clamping forces F_{y} and F_{z} imposed by the clamp mechanism 94. By way of example, FIGS. 6 and 7 illustrate what can often happen during clamping of the ferrule 24 within the port 92 of the polishing fixture 90. Given the relative magnitudes M_{y}, M_{z} of the clamping forces F_{y} and F_{z} and the simultaneous nature of their application to the ferrule 24, instead of the ferrule 24 moving in the Z direction to engage the B datum surface of the ferrule 24 with the E datum surface of the port 92 of the polishing fixture 90, the ferrule 24 binds when an upper portion of the B datum surface on the ferrule 24 contacts the lower edge (corner) of the E datum surface of the port 92 polishing fixture 90. Thus, as the actuator 96 continues to move and apply force, the ferrule 24 cants or rotates about the binding point, as illustrated by arrow R₁. As illustrated by this figure, the ferrule 24 fails to reach its predetermined position in both the Y direction and the Z direction within the port 92 of the polishing fixture 90. Accordingly, the ferrule end face 56, which is positioned just outside of the port 92 of the polishing fixture 90 is also not in its desired and predetermined location. Thus, polishing processes performed on the ferrule end face 56 and optical fiber end faces 58 will result in a deviation in the expected geometry of the ferrule and optical fiber end faces 56, 58. Then when fiber optic cable assemblies having fiber optic connectors with deviated ferrules and optical fibers are placed into operation, the optical losses across the connection joint may be higher than expected and possibly higher than permitted under the constraints of the installation. In this case, the deviated ferrule must be discarded and the connectorization process repeated to ensure an acceptable fiber optic connector and fiber optic cable assembly. Such rework of the fiber optic connector and the fiber optic cable assembly is time consuming and expensive.

In accordance with an aspect of the disclosure, the inventors have discovered that issues in current polishing fixtures, such as that described above, may be overcome through a specific application or sequencing of the clamping forces Fₓ, F_{y}, and F_{z} on the ferrule 24 within the port 92 of the polishing fixture 90. More particularly, consistent placement of the ferrule 24 in the predetermined position in the polishing fixture may be achieved by applying the clamping forces Fₓ, F_{y}, and F_{z} in a preferred order and at preferred relative magnitudes Mₓ, M_{y}, and M_{z}. In this regard, and in general, depending on the particular process being performed on the workpiece, deviations in position of the workpiece in the port of the processing fixture may have different consequences in the quality/performance of the workpiece subjected to the process during operations utilizing of the workpiece. Generally speaking, and by way of example, a workpiece may have at least two and possibly three reference datums A, B, C for positioning the workpiece within the process fixture in a predetermined location. Deviations in the position of the three reference datums A, B, C within the processing fixture do not generally have the same impact on quality/performance of the workpiece during operation. For example, a deviation in the C reference datum may have a very low or negligible impact on the quality/performance of the workpiece during operation; deviation of the B reference datum may have a moderate impact on the quality/performance of the workpiece during operation; and a deviation of the A reference datum may have a high impact on the quality/performance the workpiece during operation. In this case, the A reference datum may be referred to as the “primary reference datum”; the B reference datum may be referred to as the “secondary reference datum”; and the C reference datum may be referred to as the “tertiary reference datum.” In other words, deviations in the position of the reference datums are ranked from most important to least important on the quality/performance of the workpiece during operation. One of ordinary skill in the art will understand how to determine the importance of the reference datums on the quality and/or performance of the workpiece during operation. By way of example, this may be done by controlled experimentation on the workpiece.

Generally, it has been discovered that the workpiece may be more consistently located at its predetermined location within the process fixture if the clamping forces on the workpiece are applied in ascending order (i.e., least important to most important). For example, in one embodiment, the secondary clamping force (i.e., the clamping force to seat the secondary reference datum) may be applied prior to applying the primary clamping force (i.e., the clamping force to seat the primary reference datum). Moreover, it has been discovered that consistent positioning of the ferrule in its predetermined location may be further achieved by ensuring that the magnitudes of the clamping force are also in ascending order (lowest magnitude to greatest magnitude). For example, in one embodiment, the magnitude of the clamping force to seat the secondary reference datum may be less than the magnitude of the clamping force to seat the primary reference datum. Furthermore, in another embodiment with at least three reference datums, while there may be some variability in when the tertiary clamping force (i.e., the clamping force to seat the tertiary reference datum) may be applied, in a preferred embodiment, the tertiary clamping force may be applied to the workpiece prior to the secondary clamping force being applied to the workpiece.

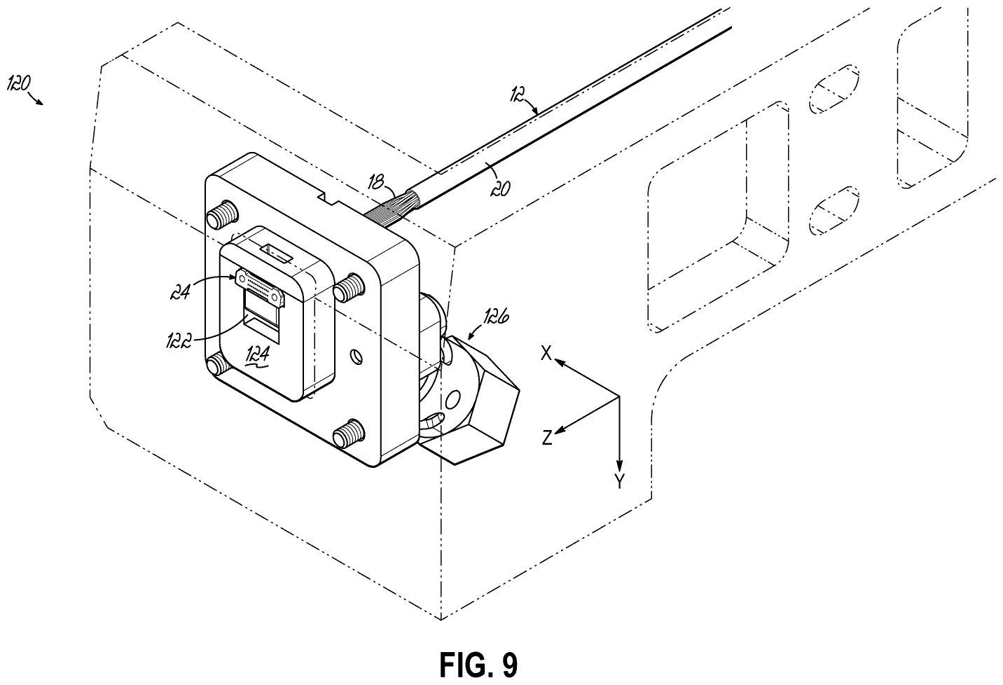

A generalized method 104 for processing a workpiece in a process fixture is illustrated in FIG. 8. The workpiece may have at least two, and possibly three reference datums. The method 104 starts with an initial step 106 of determining which of the reference datums of the workpiece constitute the tertiary reference datum, the secondary reference datum, and the primary reference datum. As noted above, one of ordinary skill in the art will understand how to do this step. This determination may depend on the particular process being performed on the workpiece and may include determining the impact that deviations in the position of the workpiece in the process fixture have on the quality/performance of the workpiece during operation. The workpiece may then be inserted into the process fixture in a step 108. In a next step 110, a clamping force F₁ may be applied to seat the tertiary reference datum relative to the process fixture at a first magnitude Mₜ. In a next step 112, a clamping force Fₛ may be applied to seat the secondary reference datum relative to the process fixture at a second magnitude Mₛ. The second magnitude Mₛ of the clamping force Fₛ is greater than the first magnitude Mₜ of the clamping force Ft. In a further step 114, a clamping force Fₚ may be applied to seat the primary reference datum relative to the process fixture at a third magnitude Mₚ. The third magnitude Mₚ of the clamping force Fₚ is greater than the second magnitude Mₛ of the clamping for Fₛ. In another step 116, the workpiece may be subjected to various processing steps while clamped within the process fixture.

Turning now to the application of processing a ferrule 24 in a polishing fixture 120, it has been discovered that deviations in the predetermined position of the ferrule 24 in the port 122 of the polishing fixture 120 in the X direction have very little effect on the quality/performance of end faces 56, 58 of the ferrule 24 and the optical fibers 18, respectively, during operation. In other words, additional optical losses across an optical connection due to deviations in X direction positioning of the ferrule 24 in the port 122 of the polishing fixture 120 is expected to be very low. Consequently, the X direction reference datum, which corresponds to the C datum surface of the ferrule 24, may be identified as the tertiary reference datum. It has also been discovered that deviations in the predetermined position of the ferrule 24 in the polishing fixture 120 in the Z direction have a moderate effect on the quality/performance of end faces 56, 58 of the ferrule 24 and the optical fibers 18, respectively, during operation. In other words, additional optical losses across an optical connection due to deviations in Z direction positioning of the ferrule 24 in the port 122 of the polishing fixture 120 is expected to be moderate. Consequently, the Z direction reference datum, which corresponds to the B datum surface of the ferrule 24, may be identified as the secondary datum reference. Lastly, it has been discovered that deviations in predetermined position of the ferrule 24 in the polishing fixture 120 in the Y direction have a significant effect on the quality/performance of end faces 56, 58 of the ferrule 24 and the optical fibers 18, respectively, during operation. In other words, additional optical losses across an optical connection due to deviations in Y direction positioning of the ferrule 24 in the port 122 of the polishing fixture 120 is expected to be the most significant. Consequently, the Y direction reference datum, which corresponds to the A datum surface of the ferrule 24, may be identified as the primary reference datum.

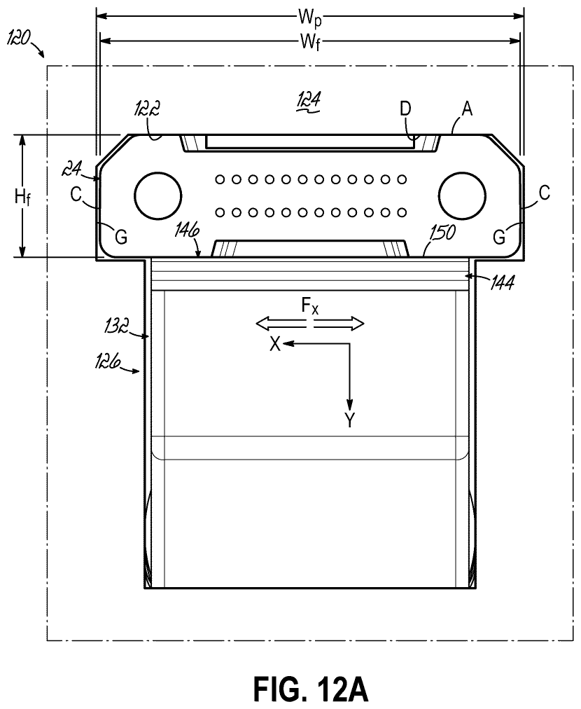

With step 106 of method 104 now completed for the application of a ferrule 24 being subjected to a polishing process, the ferrule 24 may be inserted into the port 122 of the polishing fixture 120 according to step 108. In this regard, the ferrule 24 may be loaded into the port 122 of the polishing fixture 120 from the rear so as to accommodate the optical fibers 18 that are connected to and extending away from the ferrule 24. Steps for securing the ferrule 24 within the polishing fixture 120 according to method 104 may now be implemented in the proper sequence. In this regard, in one embodiment, a first clamp mechanism may be activated to so that the C datum surface of the ferrule 24 (i.e., the tertiary reference datum) engages with the G datum surface of the port 122 of the polishing fixture 120. For example, the first clamp mechanism may be a linear actuator that applies a clamping force Fₓ on the ferrule 24 so that the C datum surface and the G datum surface are engaged. As mentioned above, it was discovered that mispositioning the ferrule 24 in the X direction has a very low effect on the quality/performance of the fiber optic connector 14 during operation. Accordingly, as best illustrated in FIG. 12A, in an alternative embodiment, the first clamp mechanism may be omitted and the port 92 in the polishing fixture 120 may have a width Wₚ just slightly larger than the width Wᵣ of the ferrule 24 to provide a snug fit. Thus, the ferrule 24 has very little wiggle room in the X direction, and what wiggle there is has essentially no effect on the quality/performance of the ferrule 24 of the fiber optic connector 14.

Moving to the next step 112 of the method 104, in one embodiment, a second clamp mechanism may be activated so that the B datum surface of the ferrule 24 (i.e., the secondary reference datum) engages with the E datum surface of the port 122 of the polishing fixture 120. For example, the second clamp mechanism may be a linear actuator that applies a clamping force F_{z} on the ferrule 24 so that the B datum surface and the E datum surface are engaged. Similarly, moving to the next step 114 of the method 104, in one embodiment, a third clamp mechanism may be activated so that the A datum surface of the ferrule 24 (i.e., the primary reference datum) engages with the D datum surface of the port 122 of the polishing fixture 120. For example, the second clamp mechanism may be a linear actuator that applies a clamping force F_{y} on the ferrule 24 so that the A datum surface and the D datum surface are engaged.

In accordance with the method 104, the clamping force Fₓ imposed on the ferrule 24 from the first clamp mechanism has the lowest magnitude Mₓ of the clamping forces Fₓ, F_{y}, F_{z}, imposed on the ferrule 24. In one embodiment, the magnitude M_{z} of the clamping force F_{z} imposed on the ferrule 24 from the second clamp mechanism may be greater than the magnitude Mₓ of the clamping force Fₓ imposed by the first clamp mechanism. Additionally, the magnitude M_{y} of the clamping force F_{y} imposed on the ferrule 24 from the third clamp mechanism may be greater than the magnitude M_{z} of the clamping force F_{z} imposed by the second clamp mechanism. By way of example, and without limitation, the magnitude M_{y} of the clamping force F_{y} may be at least 5 times greater than the magnitude M_{z} of the clamping force F_{z} imposed by the second clamp mechanism. In one embodiment, the magnitude M_{y} of the clamping force F_{y} may be between about 5 and about 20 times greater than the magnitude M_{z} of the clamping force F_{z} imposed by the second clamp mechanism.

After applying the steps 110-114 of method 104 to secure the ferrule 24 to the port 122 of the polishing fixture 120, the polishing process on the end face 56 of the ferrule 24 and the end faces 58 of the optical fibers 18 may commence. Those of ordinary skill in the art understand the various polishing processes traditionally performed on ferrules 24 and optical fibers 18 and, for brevity, a further discussion of such processes will not be described herein. Once the polishing process has been completed, the first (if present), second, and third clamp mechanisms may be released and the ferrule 24 may be removed from the port 122 of the polishing fixture 120. From here, other processes, such as measurement processes and/or assembly processes (e.g., of the housing assembly 22, spring 48, guide pin subassembly 50 (if present), crimp body 26, crimp band 38 and boot subassembly 52) may be performed to complete the assembly of the fiber optic connector 14.

In one embodiment (not shown), the polishing fixture 120 may include three different (e.g., separate) clamp mechanisms for imposing clamping forces Fₓ, F_{y}, and F_{z} at magnitudes Mₓ, M_{y}, and M_{z} of the ferrule 24. In one embodiment, the clamp mechanisms may each be independently controlled and operated from the other clamp mechanisms. As noted above, in one embodiment, the clamp mechanism for the tertiary reference datum (the clamp mechanism for imposing the clamping force Fₓ) may be omitted and the ferrule 24 may be snugly received in the port 122 of the polishing fixture 120 so as to provide very little wiggle room in the X direction. Again, this embodiment remains possible because the effect of X-direction deviations has minimal effect on the optical losses of the corresponding fiber optic connector 14 across an optical connection.

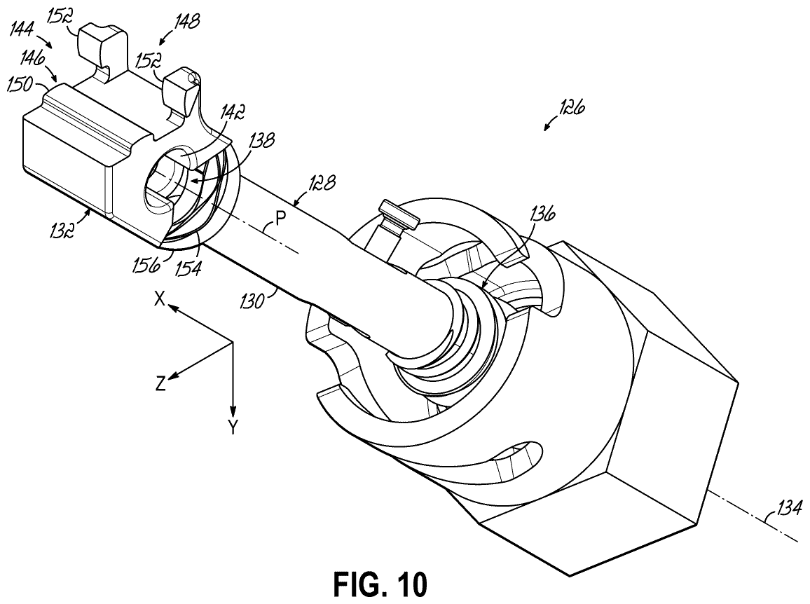

FIG. 9 illustrates a polishing fixture 120 having an alternative clamping arrangement in accordance with an embodiment of the disclosure. As illustrated, the polishing fixture 120 includes a processing interface 124 open to the port 122 that is configured to receive the ferrule 24 therein. As discussed above, in one embodiment, the ferrule 24 and the optical fibers 18 extending from the rear of the ferrule 24 may be loaded into the polishing fixture 120 from the rear side of the port 122 such that a small length of the ferrule 24 extends from the port 122 at the processing interface 124. In one embodiment, the polishing fixture 120 may include a first clamp mechanism for imposing the clamping force Fₓ on the C datum surface (i.e., the tertiary reference datum). In an alternative embodiment, and as illustrated in FIG. 9, the first clamp mechanism may be omitted and the ferrule 24 may be snugly received within the port 122 of the polishing fixture 120 with little to no wiggle room in the X direction.

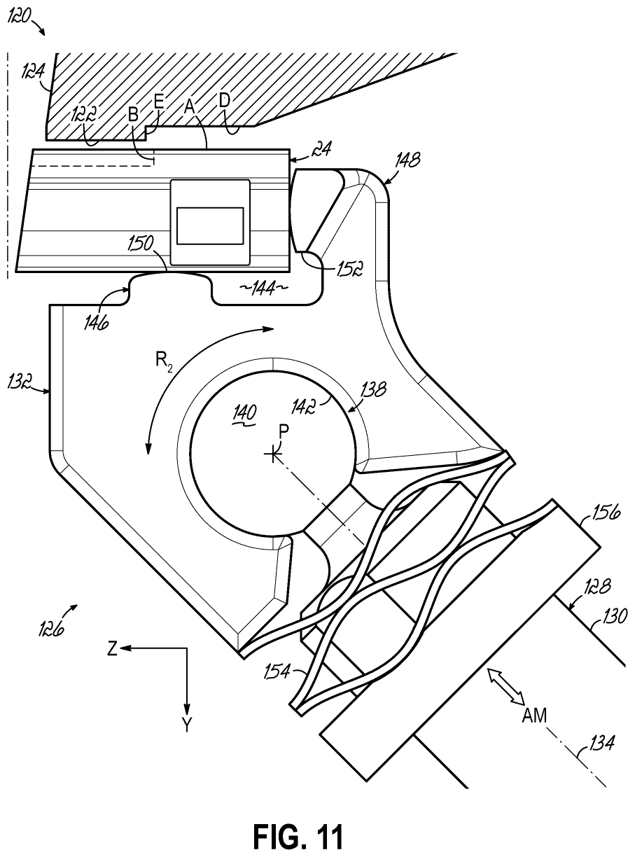

In this embodiment, and much like existing polishing fixtures, the polishing fixture 120 may include a single clamp mechanism 126 configured to impose the clamping force F_{z} on the B datum surface (i.e., the secondary reference datum) of the ferrule 24, and the clamping force F_{y} on the A datum surface (i.e., the primary reference datum) of the ferrule 24. FIGS. 10-12 illustrate the clamp mechanism 126 in accordance with an exemplary embodiment of the disclosure. The clamp mechanism 126 includes a linear actuator 128 having an actuator arm 130 and a headpiece 132 at the distal end of the actuator arm 130. In one embodiment, the actuator arm 130 is extendable and contractable along an actuator arm axis 134 under operation of a motive force generator 136. The motive force generator 136 is configured to cause the selective extension and contraction of the actuator arm 130. In one embodiment, the motive force generator 136 may be an electric motor, pneumatic motor, or hydraulic motor. Alternatively, the motive force generator 136 may be an electric pump, pneumatic pump, or hydraulic pump. Still further, the motive force generator 136 may take other forms that cause the actuator arm 130 to selectively extend or contract.

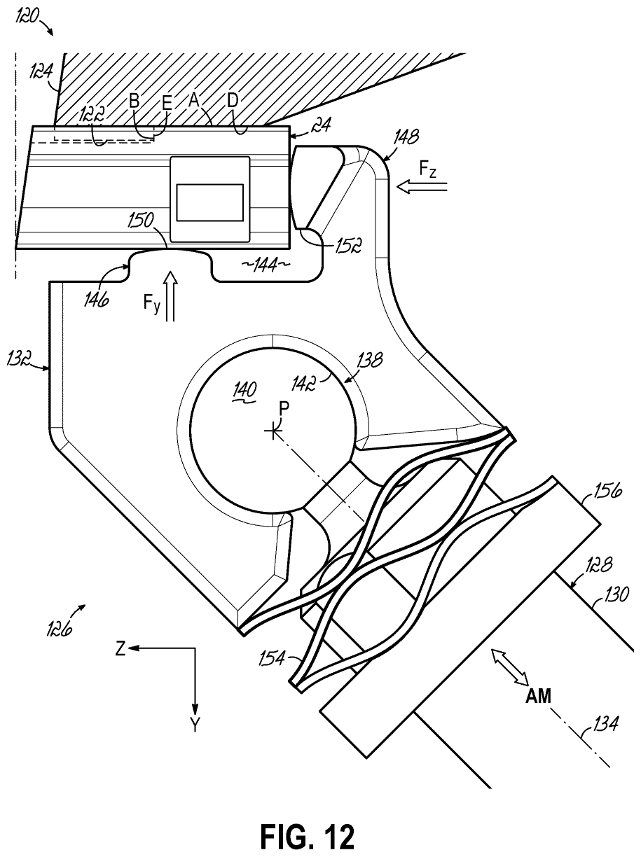

Similar to the above, the headpiece 132 of the linear clamp mechanism 126 is configured to engage with the ferrule 24 and impose the clamping forces F_{z}, F_{y} on the ferrule 24 at magnitudes M_{z}, M_{y}, respectively. Recall that in prior polishing fixtures with a combined clamp mechanism, the headpiece is fixed relative to the actuator arm. In one embodiment of this disclosure, however, the actuator 128 is provided with an additional degree of freedom. More particularly, in one embodiment, the headpiece 132 of the actuator 128 may be provided with a rotational degree of freedom relative to the actuator arm 130. Relative to the Cartesian coordinate system for the ferrule 24 described above, the headpiece 132 of the actuator 128 may be rotatable about a pivot axis P that is substantially parallel to the X-axis of the Cartesian coordinate system described above. As best illustrated in FIGS. 10-12, in one embodiment, the rotational degree of freedom may be provided by a ball and socket connection joint 138 between the actuator arm 130 and the headpiece 132. More particularly, the distal end of the actuator arm 130 may include a ball 140 and the headpiece 132 may include a socket 142 that is configured to receive the ball 140. The socket 142 has an arcuate shape that matches the arcuate shape of the ball 140. This allows the headpiece 132 to rotate about the rotational pivot axis P at the center of the ball 140. This is demonstrated by double headed arrow R₂ in FIG. 11, for example.

The headpiece 132 may further include a ferrule receiving pocket 144 configured to receive the ferrule 24 therein during engagement of the clamp mechanism 126 with the ferrule 24. In an exemplary embodiment, the ferrule receiving pocket 144 may include a primary pusher 146 and a secondary pusher 148. The primary pusher 146 is configured to engage the primary reference datum of the ferrule 24 into engagement with the corresponding reference datum in the port 122 of the polishing fixture 120, i.e., the A datum surface on the ferrule 24 into engagement with the D datum surface associated with the port 122 of the polishing fixture 120. In one embodiment, the primary pusher 146 may include one or more raised bosses 150 configured to engage with the ferrule 24. In the illustrated embodiment, for example, the boss 150 of the primary pusher 146 may include a continuous ridge that spans across substantially the entire width Wᵣ of the ferrule 24. In an alternative embodiment (not shown), the one or more bosses 150 may include multiple discrete boss sections. Similarly, the secondary pusher 148 is configured to engage the secondary reference datum of the ferrule 24 into engagement with the corresponding reference datum in the port 122 of the polishing fixture 120, i.e., the B datum surface on the ferrule 24 into engagement with the E datum surface associated with the port 122 of the polishing fixture 120. In one embodiment, the secondary pusher 148 may include one or more raised bosses 152 configured to engage with the ferrule 24. In the illustrated embodiment, for example, the one or more bosses 152 of the secondary pusher 148 may include two discrete bosses 152 along the width W_{f} of the ferrule 24. The positioning of the bosses 152 are configured to avoid interference with the optical fibers 18 connected to the ferrule 24. Other arrangements of the secondary pusher 148 may also be possible.

As best illustrated in FIG. 12, the rotational degree of freedom of the headpiece 132 relative to the actuator arm 130 about pivot axis P may be biased to a predetermined orientation of the headpiece 132 relative to the actuator arm 130 via a spring 154 or other type of biasing member. The spring biasing of the headpiece 132 relative to the actuator arm 130 is configured to orient the headpiece 132 relative the ferrule 24 positioned in the port 122 of the polishing fixture 124 such that the secondary pusher 148 engages with the ferrule 24 prior to the primary pusher 146 engaging with the ferrule 24. Thus, the secondary pusher 148 applies the clamping force F_{z} to engage the secondary reference datum of the ferrule 24 against the corresponding reference datum of the port 122 of the polishing fixture 120 (i.e., engage the B datum surface of the ferrule 24 against the E datum surface of the port 122 of the polishing fixture 120) prior to the primary pusher 146 applying the clamping for F_{y} to engage the primary reference datum of the ferrule 24 against the corresponding reference datum of the port 122 of the polishing fixture 120 (i.e., engage the A datum surface of the ferrule 24 against the D datum surface of the port 122 of the polishing fixture 120). The spring 154 is also configured to provide some give in the Z direction so that the magnitude M_{z} of the clamping force F_{z} will be less than the magnitude M_{y} of the clamping force F_{y}. In other words, the presence of the spring 154 provides the desired levels in the magnitudes M_{z}, M_{y} of the clamping forces F_{z}, F_{y} in accordance with the exemplary method described above. In this regard, the actuator arm 130 may include a collar 156 that captures the spring 154 between the headpiece 132 and the collar 156 for applying the spring bias.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The disclosure in its broader aspects is therefore not limited to the specific details, representative apparatus and methods and illustrative examples shown and described. Instead, it should be evident that departures may be made from such details without departing from the scope of the disclosure.

What is claimed is:

1. A method of polishing a ferrule of a fiber optic connector, the ferrule having a plurality of fiber bores each receiving a respective one of a plurality of optical fibers, the ferrule further defining at least two reference datums, one of the at least two reference datums being a primary reference datum and another of the at least two reference datums being a secondary reference datum, the method comprising:
inserting the ferrule in a port of a fixture;
securing the ferrule within the port of the fixture, comprising:
imposing a first clamping force (F₁) on the ferrule to engage the secondary reference datum of the ferrule with a first reference datum associated with the fixture;
subsequently imposing a second clamping force (F₂) on the ferrule to engage the primary reference datum of the ferrule with a second reference datum associated with the fixture; and
polishing an end face of the ferrule while the ferrule is secured to the port of the fixture.

2. The method of claim 1, wherein:
imposing the first clamping force (F₁) on the ferrule includes imposing the first clamping force (F₁) with a first magnitude (M₁); and
imposing the second clamping force (F₂) on the ferrule includes imposing the second clamping force (F₂) with a second magnitude (M₂),
wherein the second magnitude (M₂) is greater than the first magnitude (M₁).

3. The method of claim 1, wherein:
imposing the first clamping force (F₁) on the ferrule further comprises activating a first clamp mechanism;
imposing the second clamping force (F₂) on the ferrule further comprises activating a second clamp mechanism; and
the first clamp mechanism and the second clamp mechanism are separate from each other and independently controlled.

4. The method of claim 3, further comprising reducing a magnitude (M₁) of the first clamping force (F₁) after the second clamping force (F₂) is imposed.

5. The method of claim 1, wherein imposing the first clamping force (F₁) on the ferrule and imposing the second clamping force (F₂) on the ferrule further comprises activating a first clamp mechanism to impose both the first clamping force (F₁) and the second clamping force (F₂) on the ferrule.

6. The method of claim 1, wherein the at least two reference datums of the ferrule further includes a tertiary reference datum, and wherein the method further comprises imposing a third clamping force (F₃) on the ferrule to engage the tertiary reference datum of the ferrule with a third reference datum associated with the fixture.

7. The method of claim 6, wherein imposing the third clamping force (F₃) on the ferrule includes imposing the third clamping force (F₃) on the ferrule prior to imposing the first clamping force (F₁) on the ferrule.

8. The method of claim 6, wherein imposing the third clamping force (F₃) on the ferrule includes imposing the third clamping force (F₃) with a third magnitude (M₃), and wherein the third magnitude (M₃) is less than the first magnitude (M₁).

9. The method of claim 6, wherein imposing the third clamping force (F₃) on the ferrule further comprises activating a third clamp mechanism.

10. The method of claim 1, wherein:
the ferrule includes a generally rectangular ferrule body defining a top surface, a bottom surface, opposed side surfaces, a front end face, and a rear end face, the plurality of fiber bores extending between the rear end face and the front end face;
the ferrule further includes a cavity in the top surface of the ferrule body that extends from the front end face toward the rear end face for part of a length of the ferrule, the cavity being open to the front end face of the ferrule body and including opposed side walls and a rear wall, and the cavity extending from the top surface toward the bottom surface for part of a height of the ferrule body, the top surface of the ferrule body serves as the primary reference datum; and
the rear wall of the cavity in the top surface serves as the secondary reference datum.

11. A fixture for polishing a ferrule of a fiber optic connector, the ferrule connected to a plurality of optical fibers, the ferrule further defining at least two reference datums, one of the at least two reference datums being a primary reference datum and another of the at least two reference datums being a secondary reference datum, the fixture comprising:
a fixture port configured to receive the ferrule therein; and
at least one clamp mechanism for clamping the ferrule within the port in a predetermined location, the at least one clamp mechanism configured to impose a first clamping force (F₁) on the ferrule to engage the secondary reference datum of the ferrule with a first reference datum associated with the fixture, and subsequently impose a second clamping force (F₂) on the ferrule to engage the primary reference datum of the ferrule with a second reference datum associated with the fixture.

12. The fixture of claim 11, wherein the at least one clamp mechanism includes a plurality of clamp mechanisms, the plurality of clamp mechanisms comprising:
a first clamp mechanism for imposing the first clamping force (F₁) on the ferrule; and
a second clamp mechanism for imposing the second clamping force (F₂) on the ferrule,
wherein the first clamp mechanism and the second clamp mechanism are separate from each other and independently controlled.

13. The fixture of claim 11, wherein the at least one clamp mechanism comprises a first clamp mechanism for imposing the first clamping force (F₁) on the ferrule and imposing the second clamping force (F₂) on the ferrule.

14. The fixture of claim 13, wherein the first clamp mechanism comprises:
an actuator arm movable along an actuator axis between an extended position and a retracted position; and
a headpiece connected to an end of the actuator arm,
wherein in the extended position, the headpiece is configured to contact the ferrule and clamp the ferrule to the port of the fixture in the predetermined position, and
wherein in the retracted position, the headpiece is configured to be in non-contact relation with the ferrule.

15. The fixture of claim 14, wherein the headpiece has a rotational degree of freedom relative to the actuator arm.

16. The fixture of claim 14, wherein the first clamp mechanism further comprises a spring to bias the headpiece relative to the actuator arm.

17. The fixture of claim 14, wherein the at least one clamp mechanism further comprises a motive force generator for moving the actuator arm between the extended position and the retracted position.

18. The fixture of claim 11, wherein the at least one clamp mechanism is configured to:
impose the first clamping force (F₁) with a first magnitude (M₁); and
impose the second clamping force (F₂) with a second magnitude (M₂),
wherein the second magnitude (M₂) is greater than the first magnitude (M₁).

19. The fixture of claim 11, wherein the at least two reference datums of the ferrule further includes a tertiary reference datum, wherein the at least one clamp mechanism includes a third clamp mechanism configured to impose a third clamping force (F₃) on the ferrule, and wherein the third clamp mechanism is configured to impose the third clamping force (F₃) with a third magnitude (M₃) that is less than the first magnitude (M₁).

20. A method of making a fiber optic cable assembly, comprising:
stripping an end of a fiber optic cable carrying a plurality of optical fibers to expose a length of the optical fibers;
loading one or more components of a fiber optic connector onto the stripped end of the fiber optic cable;
securing the optical fibers to a ferrule of the fiber optic connector, the ferrule having a plurality of fiber bores each receiving a respective one of a plurality of optical fibers, the ferrule further defining at least two reference datums, and one of the at least two reference datums being a primary reference datum and another of the at least two reference datums being a secondary reference datum;
inserting the ferrule in a port of a fixture;
securing the ferrule within the port of the fixture, comprising:
imposing a first clamping force (F₁) on the ferrule to engage the secondary reference datum of the ferrule with a first reference datum associated with the fixture; and
subsequently imposing a second clamping force (F₂) on the ferrule to engage the primary reference datum of the ferrule with a second reference datum associated with the fixture;
polishing an end face of the ferrule while the ferrule is secured to the port of the fixture; and
assembling the one or more components with the ferrule to complete the assembly of the fiber optic connector on the end of the fiber optic cable.
